(19) United States
(12) Patent Application Publication
(10) Pub. No.: US 2020/0249899 A1
(43) Pub. Date: Aug. 6, 2020

(54) DISPLAY DEVICE

(71) Applicant: HONDA MOTOR CO., LTD., Tokyo (JP)

(72) Inventors: Kotaro Higuchi, Wako-shi (JP); Masaru Aoki, Wako-shi (JP)

(21) Appl. No.: 16/748,844

(22) Filed: Jan. 22, 2020

(30) Foreign Application Priority Data
Feb. 1, 2019 (JP) 2019-017081

(51) Int. Cl. G06F 3/14; B60K 35/00

(52) U.S. Cl. CPC G06F 3/1446; G06F 3/0412; B60K 35/00

(57) ABSTRACT

A display device includes a first display configured to display information, a second display configured to display information, a display controller configured to determine the content of information to be displayed on each of the first and second displays and to display the determined information on each of the first and second displays, a first receiver configured receive an operation of a user; and a second receiver configured receive an operation of a user, wherein the display controller is configured to display predetermined information across the first and second displays in a case where the first receiver receives a predetermined operation, and the display controller is configured to display the predetermined information on the second display in a case where the second receiver receives the predetermined operation.

### CROSS-REFERENCE TO RELATED APPLICATION

This application claims priority to and the benefit from Japanese Patent Application No. 2019-017081, filed on Feb. 1, 2019, the contents of which are hereby incorporated by reference into the present application.

### BACKGROUND OF THE INVENTION

### Field of the Invention

The present invention relates to a display device.

### Description of Related Art

Conventionally, a display device which uses two display monitors in a connected state is known (for example, see Japanese Unexamined Patent Application, First Publication No. H6-19433, hereinafter, referred to as Patent Document 1). In this display device, by displaying a figure or the like across the two display monitors, for example, it is possible to display the entire figure without omitting a portion of the figure even if the figure or the like occupies a large display area.

In the display device disclosed in Patent Document 1, when various pieces of information such as the information of the figure are displayed, how these pieces of information will be displayed is not discussed. Therefore, there is a problem that even though a display device includes a plurality of display monitors, it is difficult to display a plurality of pieces of information effectively.

Particularly, when there are a plurality of receivers that receive operations to be displayed on the display device, a mode of displaying information effectively differs depending on the receiver that receives an operation. However, in the display device disclosed in Patent Document 1, since a plurality of receivers are not provided, it is not possible to display information effectively using the receiver that receives an operation.

### SUMMARY OF THE INVENTION

With the foregoing in view, one of the objects of the present invention is to provide a display device capable of displaying information effectively.

A display device according to the present invention employs the following configurations.

(1) A display device according to a first aspect of the present invention includes: a first display configured to display information; a second display configured to display information; a display controller configured to determine the content of information to be displayed on each of the first and second displays and to display the determined information on each of the first and second displays; a first receiver configured receive an operation of a user; and a second receiver configured receive an operation of a user, wherein the display controller is configured to display predetermined information across the first and second displays in a case where the first receiver receives a predetermined operation, and the display controller is configured to display the predetermined information on the second display in a case where the second receiver receives the predetermined operation.

(2) In the aspect according to (1), the display controller is configured to display the predetermined information on the first display in a case where the second display is in a locked state and the first receiver receives the predetermined operation of the user.

(3) In the aspect according to (1) or (2), the first and second displays are provided in a movable object having a driver's seat and an occupant's seat, the first display is located at a position closer to the driver's seat than the second display, and the second display is located at a position closer to the occupant's seat than the first display.

(4) In the aspect according to (3), the predetermined information is a window showing content with a history of use, the display controller is configured to display a plurality of windows to partially conceal the window adjacent to the occupant's seat side by the window located on a side close to the driver's seat in a case where the plurality of windows are displayed on the first display or in a case where the plurality of windows are displayed across the first and second displays, and the display controller is configured to display a plurality of windows to partially conceal the window adjacent to the driver's seat side by the window located on a side close to the occupant's seat in a case where the plurality of windows are displayed on the second display.

(5) In the aspect according to (4), the display controller is configured to sequentially display the plurality of windows from the driver's seat side or the occupant's seat side in ascending order of elapsed time after the use of the content.

(6) In the aspect according to (5), the display controller is configured to sequentially display the plurality of windows from the side close to the driver's seat side in ascending order of elapsed time after the use of the content in a case where a plurality of windows are displayed in the first display or in a case where a plurality of windows are displayed across the first and second displays.

(7) In the aspect according to any one of (4) to (6), the display controller is configured to display, on the driver's seat side of a window displayed on a side closest to the driver's seat, text information associated with content displayed in the window displayed on the side closest to the driver's seat in a case where the predetermined information is displayed across the first and second displays.

According to (1) to (7), it is possible to display information effectively. According to (2), it is possible to prevent other information from being displayed over necessary information.

According to (3), it is possible to display information suitable for an occupant of a vehicle at a position near the occupant.

According to (4), it is possible to display a number of pieces of information while making highly necessary information easily visible.

According to (5) and (6), it is possible to make new information easily visible.

### BRIEF DESCRIPTION OF THE DRAWINGS

FIG. 1 is a block diagram showing a display device according to an embodiment.

FIG. 2 is a diagram showing an example of a screen displayed on a display device.

FIG. 3 is a flowchart showing an example of the flow of processes executed in the display device.

FIG. 4A is a diagram showing an example of transition of display in the display device.

FIG. 4B is a diagram showing an example of transition of display in the display device.

FIG. 4C is a diagram showing an example of transition of display in the display device.

FIG. 4D is a diagram showing an example of transition of display in the display device.

FIG. 5 is a flowchart showing an example of the flow of processes executed in the display device.

FIG. 6A is a diagram showing an example of transition of display in the display device.

FIG. 6B is a diagram showing an example of transition of display in the display device.

FIG. 6C is a diagram showing an example of transition of display in the display device.

FIG. 7A is a diagram showing an example of transition of display in the display device.

FIG. 7B is a diagram showing an example of transition of display in the display device.

### DETAILED DESCRIPTION OF THE INVENTION

Hereinafter, an embodiment of a display device according to the present invention will be described with reference to the drawings. A display device 100 displays a window showing certain content (for example, content with a history of use) on a plurality of displays provided within a vehicle which is a movable object. The vehicle is an electric vehicle, for example. The vehicle may be a non-electric vehicle or a so-called gasoline or hybrid automobile. The movable object may not be a vehicle, and may be an airplane or a railway vehicle, for example.

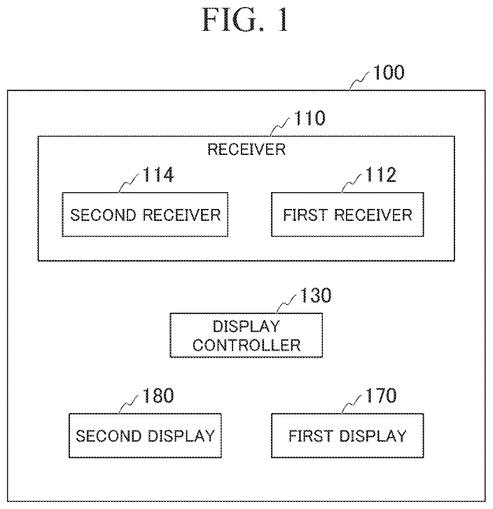

FIG. 1 is a block diagram showing a configuration of the display device 100 according to the embodiment. The display device 100 includes a receiver 110, a display controller 130, a first display 170, and a second display 180 different from the first display 170, for example. The display device 100 is a vehicle display device mounted in a vehicle, for example. The display device 100 may be a display device provided in a place other than a vehicle (for example, in a living room).

The first and second displays 170 and 180 both display various types of information. The first and second displays 170 and 180 are two touch panel display devices that are provided to be adjacent to each other, for example. The first and second displays 170 and 180 may be different regions of one display device. A remote device such as a touch pad or a commander may be used instead of or in addition to the first and second displays 170 and 180 which are touch panel display devices.

The components of part of the receiver 110 and part or all of the display controller 130 are realized by a hardware processor such as a central processing unit (CPU) executing a program (software), for example. Some or all of these components may be realized by hardware (circuit unit; including circuitry) such as a large scale integration (LSI), an application specific integrated circuit (ASIC), a field-programmable gate array (FPGA), or a graphics processing unit (GPU) and may be realized by software and hardware in cooperation. Programs may be stored in advance in a storage device (a storage device including a non-transitory storage medium) such as a hard disk drive (HDD) or a flash memory and may be stored in a removable recording medium (a non-transitory storage medium) such as DVD or CD-ROM and installed on a storage device when the storage medium is attached to a drive device.

The receiver 110 receives operations of an occupant who is a user, for example. The receiver 110 includes a first receiver 112 and a second receiver 114, for example. The first receiver 112 receives the operations of an occupant with the aid of a graphical user interface (GUI) switch set on the first display 170, for example. The second receiver 114 receives the operations of an occupant with the aid of a GUI switch set on the second display 180. The GUI switch is displayed in the form of a rectangular frame, for example.

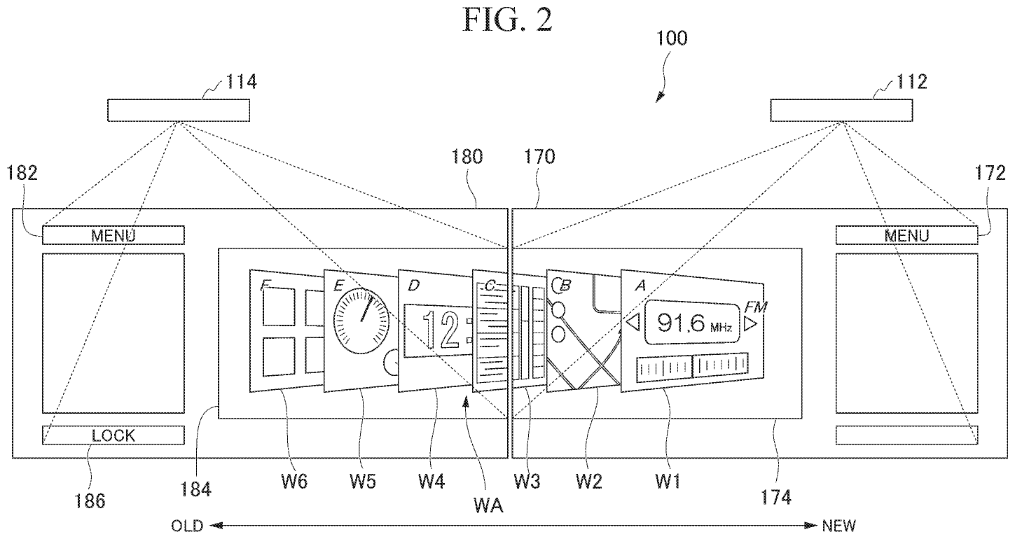

FIG. 2 is a diagram showing an example of a screen displayed on the display device 100. As showed in FIG. 2, a first menu button 172 and a first image display region 174 are set on the first display 170. The first menu button 172 is a GUI switch. For example, a GUI switch is displayed in the first image display region 174. The first menu button 172 is part of the first receiver 112. In the case of a right-hand drive vehicle, the second display 180 is located on the left side of the first display 170. For a left-hand drive vehicle, the left and right sides are reversed. Although the configuration of a right-hand drive vehicle is showed below, the left and the right may be replaced for a left-hand drive vehicle.

A second menu button 182, a second image display region 184, and a lock button 186 are set on the second display 180. The second menu button 182 and the lock button 186 are both GUI switches. A GUI switch is displayed in the second image display region 184. The first display 170, is provided at the center or close to a driver's seat of the dashboard in the passenger compartment, for example, and is located closer to the driver's seat than the second display 180. The second display 180 is provided close to a passenger seat which is an occupant's seat on the passenger compartment and is located closer to the passenger seat than the first display 170. The second menu button 182 is part of the second receiver 114.

The display controller 130 determines the content of the information to be displayed by the first and second displays 170 and 180. The display controller 130 displays the determined information on the first and second displays 170 and 180. The display controller 130 displays predetermined information on one or both of the first and second image display regions 174 and 184 on the basis of a predetermined operation received by the receiver 110. In the present embodiment, the predetermined operation is an operation of the first menu button 172 or the second menu button 182 and the predetermined information is a window group WA including a plurality of windows Wn (n: integer), for example. The operation of the first menu button 172 or the second menu button 182 is an operation of an occupant touching the first menu button 172 or the second menu button 182, for example.

The window group WA includes a first window W1 to a sixth window W6. The content displayed in the first window W1 is a radio application and the content displayed in the second window W2 is a navigation application. The content displayed in the third window W3 is a telephone application and the content displayed in the fourth window W4 is a clock application. The content displayed in the fifth window W5 is a meter display application and the content displayed in the sixth window W6 is another application. The window group may be a group of two to five windows or a group of seven windows or more, rather than a group of six windows. The number of windows can vary.

The first to sixth windows W1 to W6 are both GUI switches. When any one of the first to sixth windows W1 to W6 is touched, an application of the content indicated by the touched window among the first to sixth windows is activated. When the application is activated, the display controller 130 displays an image corresponding to the activated application in the first and second image display regions 174 and 184.

When displaying the window group WA, the display controller 130 may display the window group WA so that it fits in either the first or second image display region 174 or 184. The display controller 130 may also display the window group WA across the first and second image display regions 174 and 184.

When displaying the window group WA, the display controller 130 displays a plurality of windows Wn from the driver's seat side, starting with a window Wn (n: integer) which displays content of which the time that has elapsed since the use is the shortest. In the example showed in FIG. 2, the time that has elapsed since the use is the shortest for the content displayed in the first window W1 and is the longest for the content displayed in the sixth window W6. In other words, the content displayed in the first window W1 is content which has been used most recently among the content displayed in the first to sixth windows W1 to W6. The content displayed in the sixth window W6 is the content of which the last use time is the least recent.

The display controller 130 switches the second display 180 between a locked state and an unlocked state when the receiver 110 receives an operation of the lock button 186. When the second display 180 enters the locked state, the display controller 130 fixes the window Wn serving as a display target of the second image display region 184. For example, the second display 180 enters the locked state when the window Wn is displayed in the second image display region 184. In this case, the window Wn displayed in the second image display region 184 will not be cleared and a new window will not be displayed in the second image display region 184. When the second display 180 enters the unlocked state, the display controller 130 can change the window Wn which is to be displayed in the second image display region 184.

When an operation is received by the receiver 110 in a state in which a window Wn is displayed in either the first or second display 170 or 180, the display controller 130 may change a display mode of the window Wn being displayed already depending on the received operation. “Changing the display mode” may include an operation of changing a display position, and enlarging or reducing a display region, for example.

### [Display Mode of Display Device]

Next, a display mode of the display device 100 will be described. The first menu button 172 of the first display 170 is located on the side near the driver's seat at the upper position in a height direction, and the first image display region 174 is located in a wide region approximately at the center in the height direction closer to the left side (the passenger seat side) than the first menu button 172.

The second menu button 182 of the second display 180 is located on the side close to the passenger seat at the upper position in the height direction. The second image display region 184 is located in a wide region approximately at the center in the height direction closer to the right side (the driver's seat side) than the second menu button 182. The lock button 186 is located below the second menu button 182.

The letters “MENU” are displayed on the first menu button 172 and the second menu button 182. In the case of a right-hand drive vehicle, the first menu button 172 displayed on the first display 170 is located on the right side (the side close to the driver's seat) of the first display 170. Therefore, the first menu button 172 is easy for the driver to operate and is difficult for an occupant sitting on the passenger seat (hereinafter referred to as a “passenger”) to operate. In the case of a right-hand drive vehicle, the second menu button 182 displayed on the second display 180 is located on the left side (the side close to the passenger seat) of the second display 180. Therefore, the second menu button 182 is easy for the passenger to operate and is difficult for the driver to operate. Letters other than the letters “MENU” may be displayed on the first menu button 172 and the second menu button 182. An indication other than letters, for example, a symbol, may be displayed. Although the indications of the first menu button 172 and the second menu button 182 are the same in this example, the indications may be different.

When the first menu button 172 or the second menu button 182 is operated, the window group WA is displayed in one or both of the first and second image display regions 174 and 184. The window group WA can be displayed in the first and second image display regions 174 and 184. There may be a situation in which an image including the window group WA is displayed in the first and second image display regions 174 and 184 and a situation in which an image that does not include the window group WA is displayed in the first and second image display regions 174 and 184. In the example showed in FIG. 2, the window group WA is displayed across the first and second image display regions 174 and 184.

The letters “LOCK” are displayed on the lock button 186. The lock button 186 is located on the side close to the passenger seat, and the lock button 186 is easy for the passenger to operate and is difficult for the driver to operate. The lock button 186 is brightened when the second display 180 is in the unlocked state and is darkened when the second display 180 is in the locked state. For example, when the receiver 110 receives an operation of the lock button 186 in the unlocked state of the second display 180, the display controller 130 puts the second display 180 into the locked state and darkens the display of the lock button 186. When the receiver 110 receives an operation of the lock button 186 in the locked state of the second display 180, the display controller 130 puts the second display 180 into the unlocked state and brightens the display of the lock button 186. The lock button 186 may be displayed with letters other than the letters “LOCK.” An indication other than letters, for example, a symbol, may be displayed. The letters “LOCK” and “UNLOCK” may be displayed to correspond to the locked state and the unlocked state. In this case, the lock button 186 may not be brightened or darkened.

### [First Example of Process Flow and Display Transition of Display Device 100]

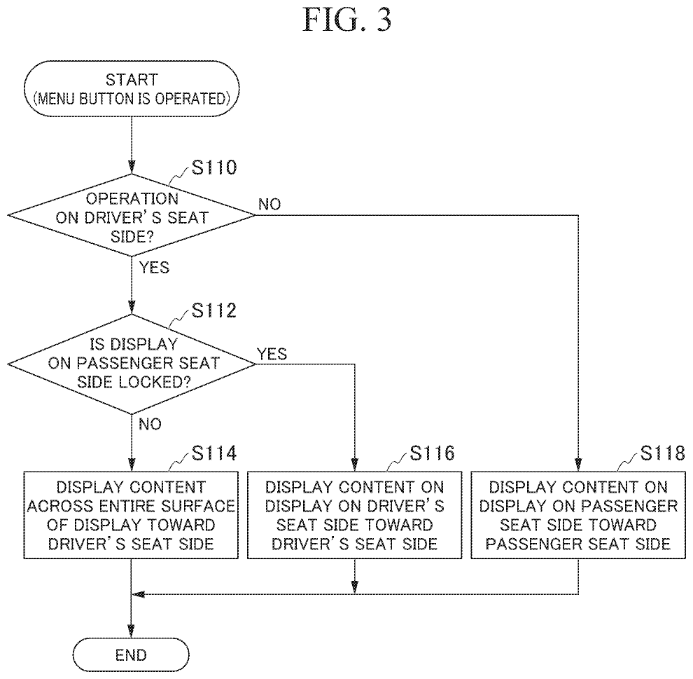

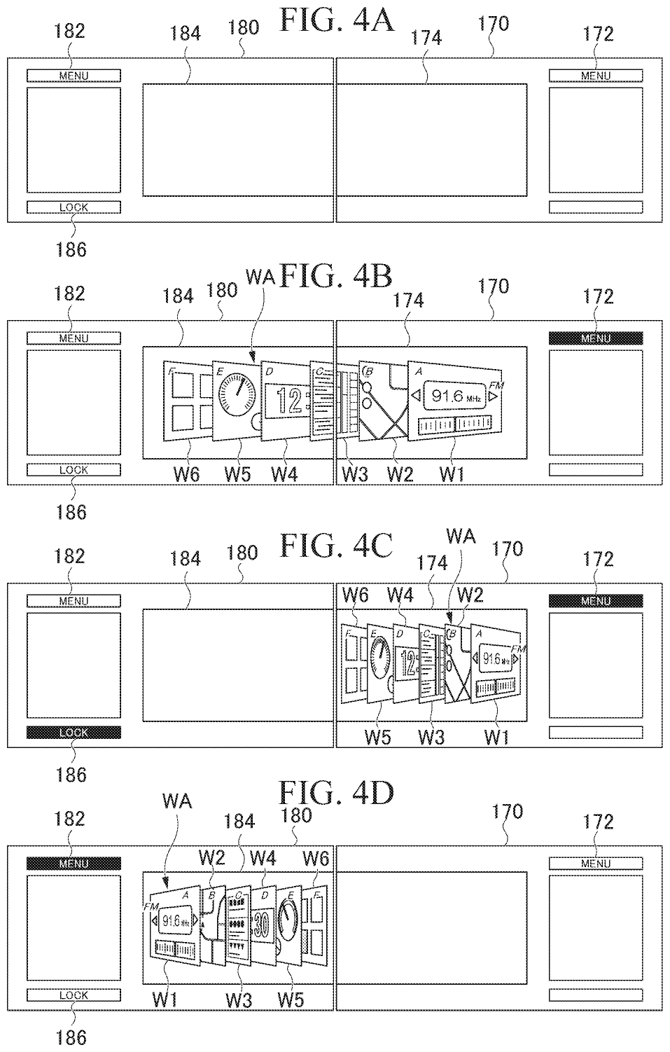

Next, a process flow of the display device 100 and transition of display in the display device 100 will be described. FIG. 3 is a flowchart showing an example of the flow of processes executed by the display device 100, and FIG. 4A to FIG. 4D are diagrams showing examples of transition of display in the display device 100. The flowchart showed in FIG. 3 starts when the receiver 110 receives an operation of either the first menu button 172 or the second menu button 182.

The display controller 130 determines whether the menu button of which the operation has been received by the receiver 110 is the first menu button 172 located on the driver's seat side (step S110). For example, as shown in FIG. 4A, in a state in which none of the GUIs is operated, the first menu button 172 or the second menu button 182 is operated, and the receiver 110 receives the operation.

As showed in FIG. 4B, the first menu button 172 is operated, and the display controller 130 determines that the menu button of which the operation has been received by the receiver 110 is the first menu button 172 located on the driver's seat side. In this case, the display controller 130 darkens the first menu button 172. Subsequently, the display controller 130 determines whether the second display 180 which is the display on the passenger seat side is in the locked state (step S112).

When it is determined that the second display 180 which is the display on the passenger seat side is in the locked state, as showed in FIG. 4B, the display controller 130 displays the window group WA across the entire area of the first and second image display regions 174 and 184 toward the driver's seat side (step S114). More specifically, the display controller 130 displays a plurality of windows Wn across the first image display region 174 of the first display 170 and the second image display region 184 of the second display 180. The display controller 130 displays substantially an entire portion of the first window W1 to be displayed closest to the driver's seat side among the plurality of windows Wn in the first image display region 174.

In this case, the display controller 130 displays text information corresponding to the content to be displayed in the first window W1 at an end close to the driver's seat side of the window (in this example, the first window W1) located closest to the driver's seat side among the window group WA. In the example showed in FIG. 4B, the first window W1 is a window indicating a radio application, for example, and the display controller 130 displays text information of the letters “FM” which is a set of broadcast stations (frequency bands) selected by the radio application at the end close to the driver's seat side of the first window W1. The letter “A” in the first window W1 is “RADIO.”

The display controller 130 displays the second window W2 adjacent to the passenger seat side of the first window W1. The display controller 130 displays the first and second windows W1 and W2 so that the first window W1 located close to the driver's seat partially conceals the second window W2 adjacent to the passenger seat side. The second window W2 is a window indicating a navigation application, for example, and the letter “B” in the second window W2 is “NAVI.”

In the same way, the display controller 130 displays the third window W3 adjacent to the passenger seat side of the second window W2 and displays the fourth window W4 adjacent to the passenger seat side of the third window W3. The display controller 130 displays the fifth window W5 adjacent to the passenger seat side of the fourth window W4 and displays the sixth window W6 adjacent to the passenger seat side of the fifth window W5. The display controller 130 displays the second to sixth windows W2 to W6 so that the second to fifth windows W2 to W5 located close to the driver's seat partially conceal the third to sixth windows W3 to W6 adjacent to the passenger seat side, respectively.

The third window W3 is a window indicating a telephone application, for example, and the letter “C” in the third window W3 is “PHONE.” The fourth window W4 is a window indicating a clock application, for example, and the letter “D” in the fourth window W4 is “CLOCK.” The fifth window W5 is a window indicating a meter display application, for example, and the letter “E” in the fifth window W5 is “METER.” The sixth window W6 is a window indicating another application, for example, and the letter “F” in the sixth window W6 is “OTHER.” In this way, the display device 100 ends the process showed in FIG. 3.

As showed in FIG. 4C, when the first menu button 172 is operated in a state in which the lock button 186 is operated and darkening display is realized, the display controller 130 determines in step S114 that the second display 180 which is a display on the passenger seat side is in the locked state. In this case, as showed in FIG. 4C, the display controller 130 displays the window group WA toward the driver's seat side while being fitted in the first display 170 which is a display on the driver's seat side (step S116).

The display controller 130 displays an entire portion of the first window W1 to be displayed closest to the driver's seat side among the plurality of windows Wn in the first image display region 174. The display controller 130 displays the second to sixth windows W2 to W6 so that the second to fifth windows W2 to W5 located close to the driver's seat partially conceal the third to sixth windows W3 to W6 adjacent to the assistant driver's seat side, respectively. In this way, the display device 100 ends the process showed in FIG. 3.

As showed in FIG. 4D, the second menu button 182 is operated, and the display controller 130 determines that the menu button of which the operation has been received by the receiver 110 is the second menu button 182 located on the passenger seat side. In this case, the display controller 130 darkens the second menu button 182. Subsequently, the display controller 130 displays the window group WA toward the passenger seat side in a state in which it is fitted in the second display 180 which is a display on the passenger seat side (step S118).

The display controller 130 displays an entire portion of the first window W1 to be displayed closest to the passenger seat among the plurality of windows Wn in the second image display region 184. The display controller 130 displays the second to sixth windows W2 to W6 so that the second to fifth windows W2 to W5 located close to the driver's seat partially conceal the third to sixth windows W3 to W6 adjacent to the passenger seat side, respectively. In this way, the display device 100 ends the process showed in FIG. 3.

### [Second Example of Process Flow and Display Transition of Display Device 100]

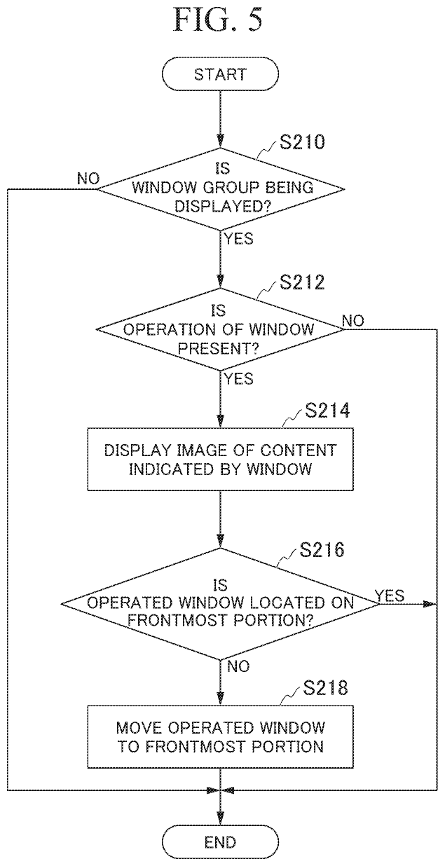

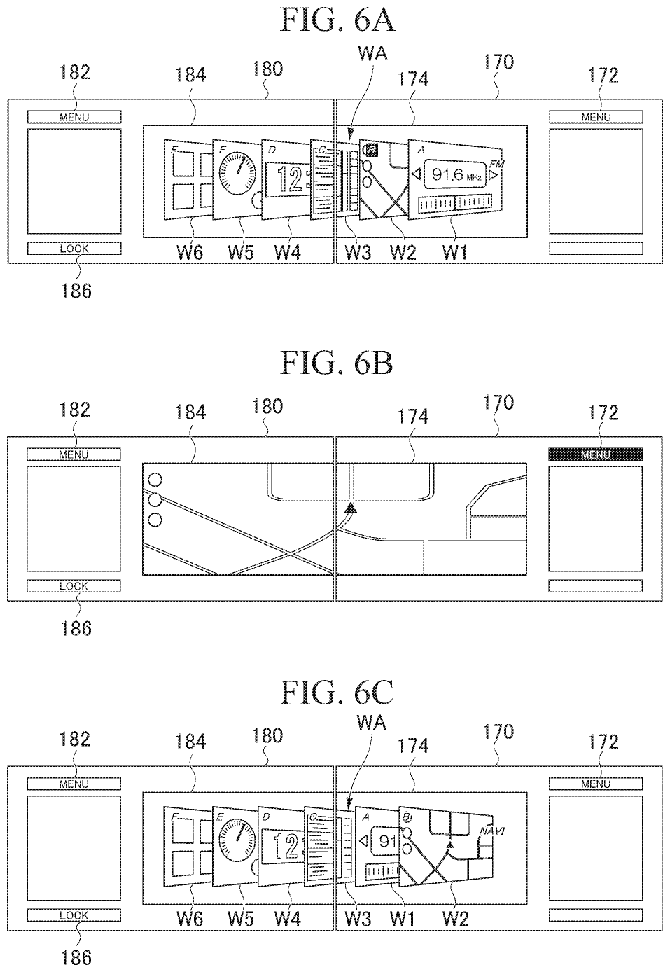

Next, the process flow of the display device 100 and display transition in the display device 100 until content to be used is selected from the content displayed on the display device 100, the image of the selected content is displayed on the display device 100, and the display of the content ends will be described. FIG. 5 is a flowchart showing an example of the flow of processes executed in the display device 100, and FIG. 6A to FIG. 6C are diagrams showing examples of transition of display in the display device 100. The flowchart showed in FIG. 5 starts when the window group WA is displayed on the display device 100.

As showed in FIG. 5, the display controller 130 determines whether the window group WA is displayed on the first or second display 170 or 180 (step S210). When it is determined that the window group WA is not displayed on the first or second display 170 or 180, the display controller 130 ends the process showed in FIG. 5.

When it is determined that the window group WA is displayed on the first or second display 170 or 180, the display controller 130 determines whether the receiver 110 has received an operation of any one of the plurality of windows Wn included in the window group WA (step S212). When it is determined that the receiver 110 has received an operation of any one of the windows Wn, the display controller 130 displays the image of content indicated by the selected window Wn on the first or second display 170 or 180 (step S214).

The display controller 130 determines whether the window Wn operated in step S212 is a window located on a frontmost portion (step S216). Here, the frontmost portion is a side closest to the driver's seat or the passenger seat and is a position at which the window is not partially concealed by the other windows Wn.

When it is determined that the operated window Wn is the window located in the frontmost portion, the display controller 130 ends the process showed in FIG. 5 without moving the operated window Wn. When it is determined that the operated window Wn is not the window located in the frontmost portion, the display controller 130 moves the operated window Wn to the frontmost portion (step S218) and ends the process showed in FIG. 5.

For example, as showed in FIG. 6A, it is assumed that the window group WA is displayed in the first and second image display regions 174 and 184. In the window group WA, the first window W1 is displayed in the frontmost portion and the fourth window W4 is displayed in the fourth place from the frontmost portion. In this state, when the second window W2 is operated, as showed in FIG. 6B, the image of the navigation application displayed in the second window W2 is displayed across the first and second image display regions 174 and 184. Although the image of the navigation application displayed in the second window W2 is displayed across the first and second image display regions 174 and 184, the image may be displayed only in the first image display region 174 and may be displayed only in the second image display region 184 depending on the type of the application. The region in which the image is displayed may be changed to one or both of the first and second image display regions 174 and 184 depending on the condition of an operation mode or the like.

After that, for example, when the first menu button 172 showed in FIG. 6B is operated, the display of the navigation application ends, and as showed in FIG. 6C, the window group WA is displayed again in the first and second image display regions 174 and 184. As showed in FIG. 6C, in the window group WA displayed in the first and second image display regions 174 and 184, the second window W2 corresponding to the navigation application displayed before the first menu button 172 was operated is displayed in the frontmost portion. The letters “NAVI” are displayed at the end on the driver's seat side of the second window W2 as the text information.

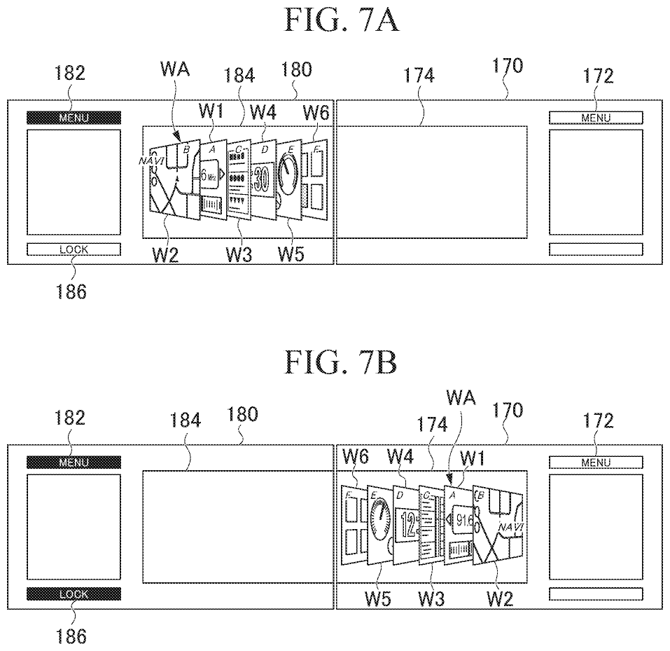

In this case, for example, when the second menu button 182 is operated, as showed in FIG. 7A, the window group WA is displayed in the second image display region 184. For example, when the second menu button 182 is operated in a state in which the lock button 186 is operated and the second display 180 is in a locked state, as showed in FIG. 7B, the window group WA is displayed in the first image display region 174.

In the display device 100 according to the embodiment of the present invention, the display controller 130 displays the plurality of windows Wn indicating a plurality of pieces of content on the first and second displays 170 and 180 as the window group WA. Although the window group WA is displayed on the first and second displays 170 and 180 when the receiver 110 receives an operation of the first or second menu button 172 or 182, for example, a display mode of the window group WA differs depending on which one of the first and second menu buttons 172 and 182 is operated. Therefore, it is possible to display information effectively depending on whether the receiver 110 having received the operation is the first or second receiver 112 or 114.

Specifically, when the first menu button 172 close to the driver's seat is operated, the window group WA is displayed across the first and second image display regions 174 and 184, whereas when the second menu button 182 is operated, the window group WA is displayed in the second image display region 184. Therefore, since the window group WA is displayed in an enlarged scale according to the operation of the first menu button 172 that is frequently operated by the driver, it is possible to lessen the burden applied to the driver who drives the vehicle when selecting and operating the windows Wn from within the window group WA. Since the window group WA is displayed in the second image display region 184 located at the position close to the passenger seat according to an operation of the second menu button 182 that is frequently operated by the assistant, it is possible to display information useful for the driver in the first image display region 174.

In the display device 100, the display controller 130 displays the window group WA in the first image display region 174 when the second display 180 is in a locked state and the first menu button 172 is operated. When the information displayed in the second display 180 is useful for the passenger and it is desired that the window group WA not be displayed in the second image display region 184 even if the window group WA is to be displayed, the second display 180 can be put into the locked state. In this case, since the window group WA is displayed in the first image display region 174 close to the driver's seat according to the operation of the first menu button 172, it is possible to display the information useful to the passenger or the like continuously in the second image display region 184 and to display the window group WA at a position close to the driver.

In the display device 100, the display controller 130 displays the window group WA so that the window Wn located on the side close to the driver's seat partially conceals the window Wn adjacent to the passenger seat side. Therefore, it is possible to display a number of windows in a state in which information for which it is highly necessary that it be located on the side close to the driver's seat is easily visible.

In the display device 100, the display controller 130 displays a plurality of windows Wn from the driver's seat side starting with the window Wn which displays content of which the time that has elapsed since the use is the shortest when displaying the window group WA. Therefore, since the window operated most recently is displayed on the driver's seat side, it is possible to make new information easily visible to the driver. Furthermore, since a plurality of windows Wn are arranged in time-series, an occupant can immediately understand the time-series order of use of content.

In the display device 100, the display controller 130 displays text information corresponding to content displayed in the window Wn at the end on the driver's seat side of the window Wn located closest to the driver's seat side of the window group WA. Therefore, the driver can easily understand the display content of the window Wn.

Although the first and second menu buttons 172 and 182 are formed by GUIs as an example in the display device 100 of the embodiment, the menu buttons may be formed by operation buttons or the like other than GUIs. The GUI may be set at a position other than the position at which it is set in the embodiment. An operation button other than the GUI may be located near the display device 100, for example, and may be displayed on the inner side of the display device 100. When the operation button is located near the display device 100, the operation button may be located at an arbitrary position such as the right side (the driver's seat side), the left side (the passenger seat side), the upper side, or the lower side of the display device 100, for example.

The lock button 186 may be formed by an operation button other than the GUI. The operation button may be located at an arbitrary position such as near the display device 100 similarly to the case described above. As a function similar to that when the lock button 186 is operated, when the GUI displayed in the first display 170 is operated, the second display 180 may enter the locked state.

Although a lock button that puts the first display 170 into the locked state is not set in the display device 100 of the embodiment, a lock button (a first lock button) that switches the locked state and the unlocked state of the first display 170 may be set. In this case, for example, a relationship between the first display 170 and the first lock button may be set similarly to a relationship between the second display 180 and the lock button 186.

Although operations of moving the window Wn included in the window group WA to change the display order thereof and remove the window Wn are not performed in the display device 100 of the embodiment, these operations may be enabled to be performed. By enabling the operations of moving and removing the window Wn to be performed, it is possible to easily customize the display of the window group WA according to the preference of an occupant. In this case, since the text information is displayed at the end of the window Wn positioned at the frontmost portion, it is possible to move the window in which it is desired to display text information to the frontmost portion.

Although the first and second displays 170 and 180 are provided in the dashboard in the passenger compartment in the display device 100 of the embodiment, the displays may be provided in another position of the vehicle. Rather than providing the first and second displays 170 and 180 directly in the dashboard or the like of the vehicle, another device such as a smartphone having two display screens, for example, may be provided by being attached to the vehicle.

While modes for implementing the present invention have been described using embodiments, the present invention is not limited to these embodiments and various modifications and substitutions can be added without departing from the scope of the present invention.

What is claimed is:

1. A display device comprising:
a first display configured to display information;
a second display configured to display information;
a display controller configured to determine the content of information to be displayed on each of the first and second displays and to display the determined information on each of the first and second displays;
a first receiver configured receive an operation of a user; and
a second receiver configured receive an operation of a user, wherein
the display controller is configured to display predetermined information across the first and second displays in a case where the first receiver receives a predetermined operation, and
the display controller is configured to display the predetermined information on the second display in a case where the second receiver receives the predetermined operation.

2. The display device according to claim 1, wherein
the display controller is configured to display the predetermined information on the first display in a case where the second display is in a locked state and the first receiver receives the predetermined operation of the user.

3. The display device according to claim 1, wherein
the first and second displays are provided in a movable object having a driver's seat and an occupant's seat,
the first display is located at a position closer to the driver's seat than the second display, and
the second display is located at a position closer to the occupant's seat than the first display.

4. The display device according to claim 3, wherein
the predetermined information is a window showing content with a history of use,
the display controller is configured to display a plurality of windows to partially conceal the window adjacent to the occupant's seat side by the window located on a side close to the driver's seat in a case where the plurality of windows are displayed on the first display or in a case where the plurality of windows are displayed across the first and second displays, and
the display controller is configured to display a plurality of windows to partially conceal the window adjacent to the driver's seat side by the window located on a side close to the occupant's seat in a case where the plurality of windows are displayed on the second display.

5. The display device according to claim 4, wherein
the display controller is configured to sequentially display the plurality of windows from the driver's seat side or the occupant's seat side in ascending order of elapsed time after the use of the content.

6. The display device according to claim 5, wherein
the display controller is configured to sequentially display the plurality of windows from the side close to the driver's seat side in ascending order of elapsed time after the use of the content in a case where a plurality of windows are displayed in the first display or in a case where a plurality of windows are displayed across the first and second displays.

7. The display device according to claim 4, wherein
the display controller is configured to display, on the driver's seat side of a window displayed on a side closest to the driver's seat, text information associated with content displayed in the window displayed on the side closest to the driver's seat in a case where the predetermined information is displayed across the first and second displays.
